(19) United States
(12) Patent Application Publication
(10) Pub. No.: US 2015/0356948 A1
(43) Pub. Date: Dec. 10, 2015

(54) METHOD FOR CALIBRATING LUMINANCE, METHOD FOR DISPLAYING IMAGE AND DISPLAY DEVICE

(71) Applicant: AmTRAN Technology Co., Ltd., New Taipei City (TW)

(72) Inventor: Shih-Pin LIN, Taoyuan City (TW)

(21) Appl. No.: 14/615,440

(22) Filed: Feb. 6, 2015

(30) Foreign Application Priority Data
Jun. 6, 2014 (TW) 103119752

(51) Int. Cl. G09G 5/10

(52) U.S. Cl. CPC G09G 5/10; G09G 2320/0626

(57) ABSTRACT

A method for calibrating a luminance includes measuring a default luminance value of a display device when the display device is set at a default user-configured luminance configuration, calculating a calibration parameter according to a target luminance value and the default luminance value, and storing the calibration parameter in the display device so that the display device exhibits a display luminance value substantially identical to the target luminance value according to the calibration parameter when the display device is set at the default user-configured luminance configuration.

### RELATED APPLICATIONS

This application claims priority to Taiwanese Application Serial Number 103119752, filed Jun. 06, 2014, which is herein incorporated by reference.

### BACKGROUND

1. Field of Invention

The present disclosure relates to a method for calibrating a luminance, a method for displaying an image, and a display device. More particularly, the present disclosure relates methods and a display device used to standardize default luminance values.

2. Description of Related Art

With rapid technology advances, display devices are widely used in people's daily live applications, such as personal computers, mobile phones, video walls and etc.

Generally speaking, a user can adjust the display luminance value of a display device by setting a user-configured luminance configuration in the display device. However, since the backlights in the same type of display devices somewhat differ in material characteristics, the display devices may exhibit different brightness even though all of the display devices are set at an identical default user-configured luminance configuration. In some particular applications (e.g., a video wall that is formed by consisting of multiple display devices), the luminance difference between the display devices may decrease the overall display quality (e.g., inducing luminance unevenness on the video wall) and cause the user inconvenience of having to re-calibrate the display luminance of the display devices.

### SUMMARY

Thus, to overcome the problem mentioned above, the present disclosure provides a method for calibrating a luminance. In accordance with one embodiment of the disclosure, the method for calibrating a luminance includes measuring, a default luminance value of a display device when the display device is set at a default user-configured luminance configuration, calculating a calibration parameter according to a target luminance value and the default luminance value, and storing the calibration parameter in the display device so that the display device exhibits a display luminance value substantially identical to the target luminance value according to the calibration parameter when the display device is set at the default user-configured luminance configuration.

In accordance with one embodiment of the present disclosure, the calibration parameter is equal to the target luminance value divided by the default luminance value.

In accordance with one embodiment of the present disclosure, the method further includes measuring a maximum luminance value of the display device when the display device is set at a maximum user-configured luminance configuration. The step of calculating the calibration parameter includes calculating the calibration parameter according to the target luminance value, the default luminance value, and the maximum luminance value.

In accordance with one embodiment of the present disclosure, the calibration parameter is equal to the target luminance value divided by a product of the maximum luminance value and the default user-configured luminance configuration.

The disclosure additionally provides a method for displaying an image. In accordance with one embodiment of the disclosure, the method includes loading a calibration parameter stored in a calibration parameter storage, wherein the calibration parameter is calculated according to a target luminance value and a default luminance value which is measured when the display device is set at a default user-configured luminance configuration; and driving the display device according to the calibration parameter so that the display device exhibits a display luminance value substantially identical to the target luminance value. Wherein, the calibration parameter may be, for example, calculated in terms of prior embodiments.

The disclosure still provides a display device. In accordance with one embodiment of the disclosure, the display device includes a panel module, a calibration parameter storage, and a controller. The calibration parameter storage is used for storing a calibration parameter calculated according to a target luminance value and a default luminance value measured when the display device is set at a default user-configured luminance configuration. The controller is used for calibrating a display luminance value of the panel module according to the calibration parameter. Wherein, the calibration parameter may be, for example, calculated in terms of preceding embodiments.

Through utilizing the calibrating method described above, the display luminance value of each display device can be calibrated to the target luminance value, further making the display luminance values of these display devices be identical.

### BRIEF DESCRIPTION OF THE DRAWINGS

FIG. 1 is a schematic diagram of a calibrating system according to one embodiment of the present disclosure.

FIG. 2 is a flowchart of a method for calibrating a luminance according to one embodiment of the present disclosure.

FIG. 3 is a flowchart of a method for calibrating a luminance according to another embodiment of the present disclosure.

FIG. 4 is a flowchart of a method for displaying an image according to another embodiment of the present disclosure.

### DETAILED DESCRIPTION

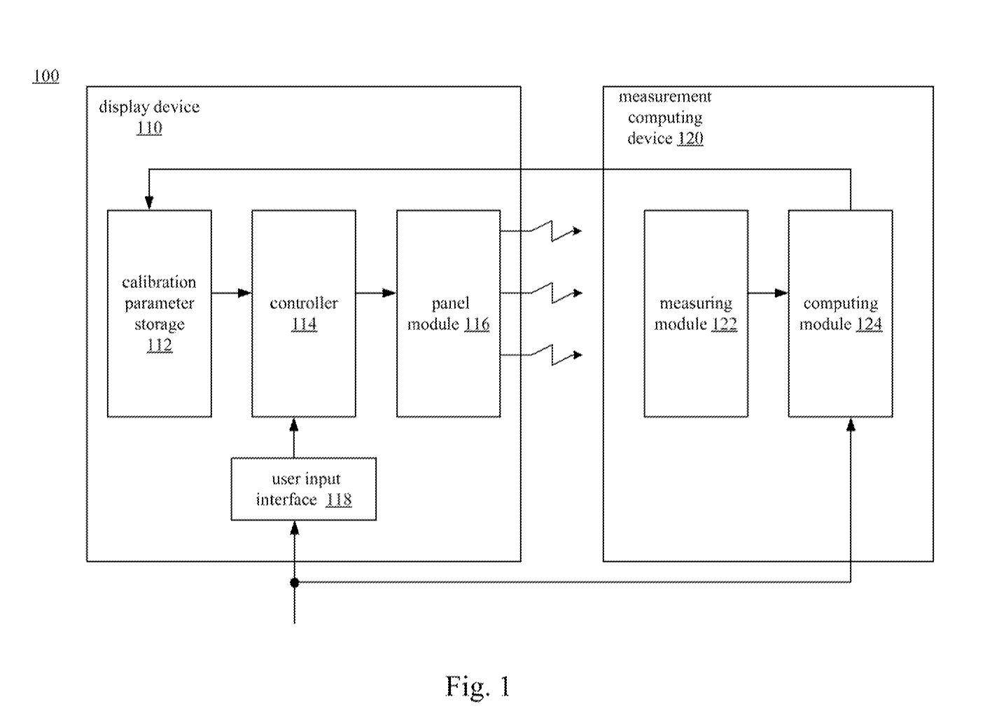

FIG. 1 is a schematic diagram of a calibrating system 100 according to one embodiment of the present disclosure. The calibrating system 100 includes a display device 110 and a measurement computing device 120.

In some approaches, a typical display device has a user-configured luminance configuration. A display luminance value exhibited by the display device is equal to a product of the value of the user-configured luminance configuration and the maximum luminance value of the display device. For example, if the maximum luminance value of the display device is 300 nits, and the value of the user-configured luminance configuration is 50%, the display luminance value exhibited by the display device may be equal to 300 nits×50%=150 nits.

However, due to manufacturing deviation, the maximum luminance values of different display devices may vary. Thus, even when the display devices have an identical user-configured luminance configuration, the display devices may still exhibit different display luminance values. As a consequence, the user is inconvenienced by having to re-calibrate the display luminance values of the display devices.

Therefore, in one embodiment of the disclosure, to avoid such a problem, a measurement computing device 120 is used to measure a display luminance value of the display device 110 and calculate a calibration parameter, so that the display luminance value of the display device 110 can be calibrated according to the calibration parameter.

In this embodiment, when the display device 110 is set at a particular user-configured luminance configuration (e.g., a default user-configured luminance configuration with a value of 50% or 70%, and/or a maximum user-configured luminance configuration with a value of 100%), the measurement computing device 120 is employed to measure the display luminance value(s) of the display device 110 and calculate the calibration parameter according to the display luminance value(s).

It should be noted that, in a different embodiment, the measurement computing device 120 may be separated into a measuring device and a computing device which are independent of each other. Thus, the present disclosure is not limited to the embodiment described above.

In this embodiment, the display device 110 and the measurement computing device 120 may interact with or control each other via an electrical connection therebetween. More specifically, during a period when the measurement computing device 120 provides the calibration parameter to the display device 110, the display device 110 and the measurement computing device 120 may electrically connect to each other. However, after the calibration parameter is stored in the display device 110, the display device 110 may be detached from the measurement computing device 120 and operate independently.

In following paragraphs, details of the display device 110 and the measurement computing device 120 in some embodiments will be described, but the disclosure is not limited to the embodiments presented below.

In one embodiment, the display device 110 includes a calibration parameter storage 112, a controller 114, a panel module 116, and a user input interface 118. In this embodiment, the controller 114 is electrically connected to the calibration parameter storage 112, the panel module 116, and the user input interface 118.

In one embodiment, the measurement computing device 120 includes a measuring module 122 and a computing module 124. The measuring module 122 is electrically connected to the computing module 124. The computing module 124 is electrically connected to the calibration parameter storage 112 of the display device 110 and capable of controlling the display device 110. The measuring module 122 is employed to measure the display luminance value of the display device 110 (i.e., the display luminance value of the panel module 116 thereof). The measuring module 122 may be, for example, a luminance sensor or a color temperature sensor. The computing module 124 is employed to calculate the calibration parameter according to the measurement result of the measuring module 122. Then, the computing module 124 may store the calibration parameter in the calibration parameter storage 112 of the display device 110.

In addition, the functions of the computing module 124 can be realized by using a central processor, a microprocessor, or other suitable computing component implementing specific commands or a specific program code.

The user input interface 118 may be employed to receive an input command and provide the input command to the controller 114. In this embodiment, the user input interface 118 may receive the input command via an on-screen display (OSD) system so as to set a user-configured luminance configuration. For example, the user can set the value of the user-configured luminance configuration as any value from 1% to 100% through the input command.

The controller 114 may be employed to control the panel module 116 to display an image according to both the calibration parameter stored in the calibration parameter storage 112 and the input command. The functions of the controller 114 can be realized by using a central processor, a microprocessor, or other suitable computing component implementing specific commands or a specific computer code. The panel module 116 may be, for example, a liquid crystal display module with a backlight, an organic light emitting diode display module, or another type of display module. The calibration parameter storage 112 may be, for example, a read only memory, a flash memory, or another suitable non-transitory storage medium.

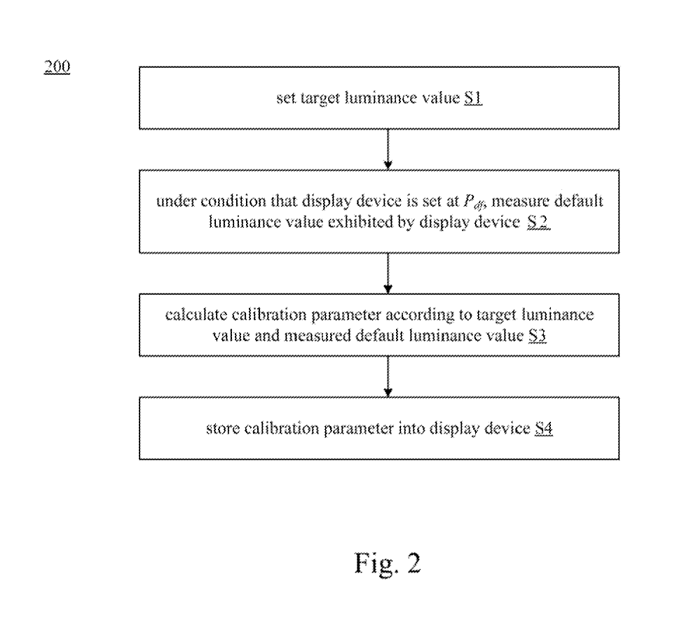

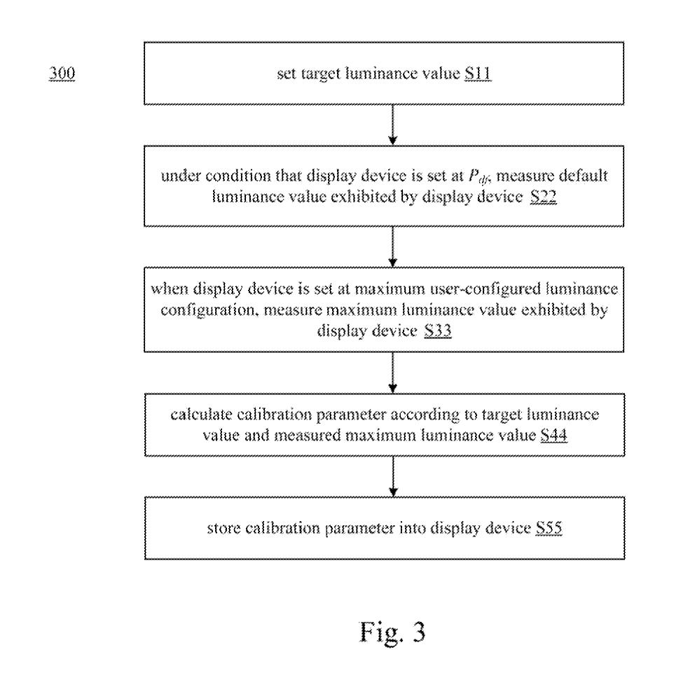

In the following paragraphs, details of the disclosure are provided with reference to FIGS. 2 and 3. However, the disclosure is not limited to the embodiments presented below.

It should be noted that a method for calibrating a luminance described below may apply to a calibrating system identical or similar to the structure shown in FIG. 1. To simplify the description below, the following paragraphs take the calibrating system 100 in FIG. 1 as an example and recite the calibrating method according to one embodiment of the disclosure. However, the disclosure is not limited to such application.

In addition, it should be noted that unless otherwise specified, the proposed steps of the calibrating method in the embodiment can be arranged in desired order according to practical needs. Even all or a part of the steps may be performed concurrently. Moreover, the steps also may be adaptively added, replaced, and/or omitted in various embodiments.

FIG. 2 is a flowchart of a method 200 for calibrating a luminance according to one embodiment of the disclosure. The method 200 includes the steps outlined below.

In step S1, a target luminance value is preset through utilizing the measurement computing device 120, In one embodiment, the target luminance value may be set as an expected display luminance value exhibited by the display device 110 set at a default user-configured luminance configuration (referred to as P_{df} hereinafter). For example, provided that the maximum luminance value of the display device 110 is expected as 300 nits and P_{df} is 50%, the target luminance value can be set as 300 nits×50%=150 nits. As another example, provided that the maximum luminance value of the display device 110 is supposed to be 300 nits and P_{df} is 70%, the target luminance value can be set as 300 nits×70%=210 nits.

In one embodiment, the target luminance value can be preset as a value slightly lower than the expected display luminance value exhibited by the display device 110 set at P_{df}, in case the maximum luminance value is smaller than an anticipated one due to manufacturing deviations to respective display devices.

In step S2, provided that the display device 120 is set at P_{df}, the measurement computing device 120 utilizes the measuring module 122 to measure a default luminance value exhibited by the display device 110.

In step S3, the measurement computing device 120 utilizes the computing module 124 to calculate a calibration parameter according to the target luminance value and the measured default luminance value.

In one embodiment, the calibration parameter is, for example, a calibration ratio which is equal to the target luminance value divided by the measured default luminance value.

In step S4, the measurement computing device 120 utilizes the computing module 124 to store the calibration parameter in the calibration parameter storage 112. Through such operation, when the display device 110 is set at P_{df}, the display device 110 can utilize its controller 114 with the calibration parameter for enabling the panel module 116 to exhibit a display luminance value substantially identical to the target luminance value.

In this embodiment, when the display device 110 is set at P_{df}, the display luminance value exhibited by the panel module 116 may be the product of the maximum luminance value of the panel module 116, the value of the default user-configured luminance P_{df}, and the value of the calibration parameter.

To make the disclosure more understandable, an operative example is illustrated below.

In this operative example, a maximum luminance value of a first display device is 280 nits, and a maximum luminance value of a second display device is 320 nits. The target luminance value is 100 nits. The default user-configured luminance P_{df} is 50%. If the measured default luminance value of the first display device is 140 nits, then the value of the calibration parameter will be 100/140. If the measured default luminance value of the second display device is 160 nits, then the value of the calibration parameter will be 100/160.

In this way, provided that the first display device is set at P_{df} (that is, the value of the user-configured luminance is set as 50%), the display luminance value exhibited by the first display device is equal to 280 nits×50%×100/140 =100 nits. Provided that the second display device is set at P_{df}, the display luminance value exhibited by the second display device is equal to 320 nits ×50%×100/160=100 nits.

Thus, through the above-mentioned setup, when both of the first and second display devices are set at P_{df}, both of the display luminance values exhibited by the first and second display devices can be calibrated to the target luminance value, so that the display luminance values exhibited by the first and second display devices can be identical to each other.

On the other hand, in above operative example, when the first display device is set at a specific the user-configured luminance (e.g., the value of the user-configured luminance is set as 80%), the display luminance value exhibited by the first display device is equal to 280 nits×80%×100/140=160 nits. When the second display device is set at the default user-configured luminance P_{df} (e.g., the value of the user-configured luminance is set as 80%), the display luminance value exhibited by the second display device is equal to 320 nits×80%×100/160=160 nits.

Thus, through above-mentioned setup, when both of the first and second display devices are set at an identical user-configured luminance, the display luminance values exhibited by the first and second display devices are identical. in such a manner, unification of display luminance specification for the first and second display devices can be achieved.

FIG. 3 is a flowchart of a method 300 for calibrating a luminance according to another embodiment of the present disclosure. The method 300 of FIG. 3 is similar to the preceding method 200, and the following description is conducted simply concerning method difference.

Details of steps S11, 522 can be seen by respectively referring to context of preceding steps S1, S2, and will not be repeated here.

In step S33, when the display device 110 is set at a maximum user-configured luminance configuration (whose value is, for example, 100%), the measurement computing device 120 utilizes the measuring module 122 to measure a maximum luminance value exhibited by the display device 110.

In step S44, the measurement computing device 120 utilizes the computing module 124 to calculate a calibration parameter according to the target luminance value and the measured maximum luminance value.

In one embodiment, the calibration parameter is equal to the target luminance value divided by a product of the measured maximum luminance value and the default user-configured luminance P_{df} (i.e., the calibration parameter=the target value I (the measured maximum luminance value×default user-configured luminance P_{df})).

Subsequently, in step S55, the measurement computing device 120 utilizes the computing module 124 to store the calibration parameter in the calibration parameter storage 112. Through such operation, when the display device 110 is set at P_{df}, the display device 110 can utilize its controller 114 with the calibration parameter for enabling the panel module 116 to exhibit a display luminance value substantially identical to the target luminance value.

Specific details of step S55 can be seen by referring to context of preceding step S4, and will not be repeated here.

To facilitate better understanding to the disclosure, another operative example is illustrated below.

In this operative example, a maximum luminance value of a first display device is 280 nits, a maximum luminance value of a second display device is 320 nits, the target luminance value is 100 nits, and the default user-configured luminance P_{df} is 50%. If the measured maximum luminance value of the first display device is 280 nits, then the calibration parameter is 100/(280×50%). If the measured maximum luminance value of the second display device is 320 nits, then the calibration parameter is 100/(320×50%).

So, provided that the first display device is set at P_{df} (that is, the user-configured luminance is set as 50%), the display luminance value exhibited by the first display device is equal to 280 nits×50%×1001(280×50%)=100nits. Provided that the second display device is set at P_{df}, the display luminance value exhibited by the second display device is equal to 320 nits×50%×100/(320×50)=100 nits.

Thus, through above scheme, when different display devices are set at the same user-configured luminance, such display devices shall exhibit the same display luminance value. Therefore, unification of luminance specifications of different display devices can be obtained.

It should be noted that, in different embodiments, step S22 can be omitted, and step S44 can be modified to calculate the calibration parameter simply according to the target luminance value and the measured default luminance value. Thus, the disclosure is not limited to previous embodiments.

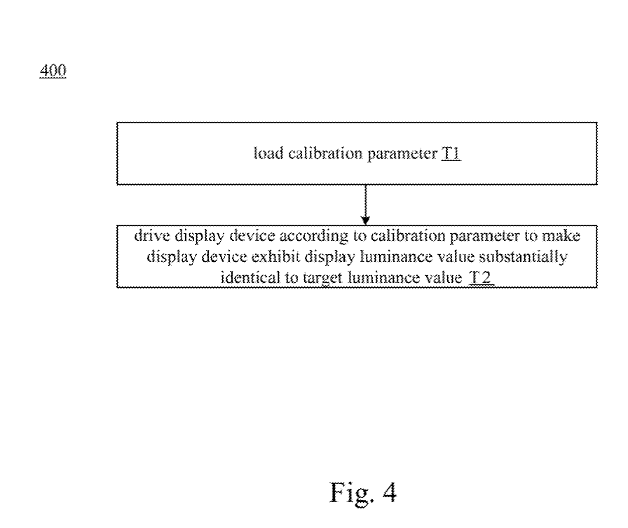

The following paragraphs, accompanying with a displaying method in FIG. 4, provides more specific details of the disclosure. However, the disclosure is not limited to below embodiment.

The underlying displaying method may apply to display devices identical or similar to the structure shown in FIG. 1. To simplify depiction, the following takes the display device 110 in FIG. 1 for example and recites the displaying method according to one embodiment of the disclosure. However, the disclosure is not limited to such application.

In addition, it should be noted that unless otherwise specified, the proposed steps of the displaying method in the embodiment can be arranged in desired order according to practical needs. Even all or a part of the steps may be performed concurrently. Moreover, the steps also may be adaptively added, replaced, and/or omitted in various embodiments.

FIG. 4 is a flowchart of a method 400 for displaying an image according to one embodiment of the present disclosure. The displaying method 400 includes below steps.

In step T1, the display device 110 utilizes the controller 114 to load a calibration parameter stored in the calibration parameter storage 112. In one embodiment, the calibration parameter is generated according to the method 200 or the method 300 described above. Details about the calibration parameter will no longer be repeated here.

In step T2, the display device 110 utilizes the controller 114 to drive the display device 110 according to the calibration parameter stored in the calibration parameter storage 112, to make the display device 110 exhibit a display luminance value substantially identical to the target luminance value. That is, the display device 110 can determine the display luminance value exhibited by the panel module 116 according to the calibration parameter and the user-configured luminance configuration.

In one embodiment, the display luminance value exhibited by the panel module 116 can be a product of the maximum luminance value of the panel module 116, a received default user-configured luminance, and the corresponding calibration parameter.

For example, provided that a maximum luminance value of a first display device is 280 nits a calibration parameter of the first display device is 100/140, a maximum luminance value of a second display device is 320 nits, and a calibration parameter of the second display device is 100/160, assuming both of the values of the user-configured luminance received by the first and second display devices are 70%, then the display luminance value exhibited by the first display device is equal to 280 nits×70%×100/140=140 nits, and the display luminance value exhibited by the second display device is equal to 320 nits×70%×100/160=140 nits.

To sum up, through above scheme, when different display devices are set at the same user-configured luminance, such display devices all exhibit the same display luminance value. Therefore, unification of luminance specifications of different display devices can be obtained, and display luminance values are standardized.

Although the disclosure has been described in considerable detail with reference to certain embodiments thereof, other embodiments are possible. Therefore, the scope of the appended claims should not be limited to the description of the embodiments contained herein.

What is claimed is:

1. A method for calibrating a luminance, comprising:
measuring a default luminance value of a display device when the display device is set at a default user-configured luminance configuration;
calculating a calibration parameter according to a target luminance value and the default luminance value; and
storing the calibration parameter in the display device so that the display device exhibits a display luminance value substantially identical to the target luminance value according to the calibration parameter when the display device is set at the default user-configured luminance configuration.

2. The method as claimed in claim 1, wherein the calibration parameter is equal to the target luminance value divided by the default luminance value.

3. The method as claimed in claim 1, further comprising:
measuring a maximum luminance value of the display device when the display device is set a maximum user-configured luminance configuration;
wherein the step of calculating the calibration parameter comprises:
calculating the calibration parameter according to the target luminance value, the default luminance value, and the maximum luminance value.

4. The method as claimed in claim 3, wherein the calibration parameter is equal to the target luminance value divided by a product of the maximum luminance value and the default user-configured luminance configuration.

5. A method for displaying an image, comprising:
loading a calibration parameter stored in a calibration parameter storage, wherein the calibration parameter is calculated according to a target luminance value and a default luminance value which is measured when the display device is set at a default user-configured luminance configuration; and
driving the display device according to the calibration parameter so that the display device exhibits a display luminance value substantially identical to the target luminance value.

6. The method as claimed in claim 5, wherein the calibration parameter is calculated according to the target luminance value, the default luminance value, and a maximum luminance value measured when the display device is set at a maximum user configured luminance configuration.

7. The method as claimed in claim 6, wherein the calibration parameter is equal to the target luminance value divided by a product of the maximum luminance value and the default user-configured luminance configuration.

8. A display device comprising:
a panel module;
a calibration parameter storage used for storing a calibration parameter, wherein the calibration parameter is calculated according to a target luminance value and a default luminance value which is measured when the display device is set at a default user-configured luminance configuration; and
a controller used for calibrating a display luminance value of the panel module according to the calibration parameter.

9. The display device as claimed in claim 8, wherein the calibration parameter is calculated according to the target luminance value, the default luminance value, and a maximum luminance value measured when the display device t a maximum user-configured luminance configuration.

10. The display device as claimed in claim 9, wherein the calibration parameter is equal to the target luminance value divided by a product of the maximum luminance value and the default user-configured luminance configuration.
